(19) United States
(12) Patent Application Publication
(10) Pub. No.: US 2007/0037504 A1
(43) Pub. Date: Feb. 15, 2007

(54) Coin sorting machine

(75) Inventor: Yoo Hong Jung, Seoul (KR)

Correspondence Address: DILWORTH & BARRESE, LLP, 333 EARLE OVINGTON BLVD., UNIONDALE, NY, 11553, US

(73) Assignee: Cosmo Information Technology Co., LTD, Seoul (KR)

(21) Appl. No.: 11/435,478

(22) Filed: May 17, 2006

(30) Foreign Application Priority Data
Aug. 10, 2005 (KR) 10-2005-0073398

(51) Int. Cl. G07D 3/00

(52) U.S. Cl. 453/12

(57) ABSTRACT

The present invention provides a coin sorting machine having a housing which has a structure such that storage casings are automatically carried, thereby rapidly sorting a great number of coins. The housing has a coin supply unit, through which coins are supplied into the housing, a coin sorting unit, which sorts the coins depending on the kinds of coins, a plurality of storage casings to store the sorted coins therein, and a carrying unit. Each storage casing includes a support having a carrying groove and a seating groove therein, and a storage part. The carrying unit includes a drive unit for rotating a plurality of rotating shafts, each of which has a screw thereon and is coupled to the support of each of the storage casings through the screw. The coin sorting machine further includes a storage casing inlet, through which the storage casings are supplied into the housing.

### PRIORITY

This application claims priority to an application entitled “Coin Sorting Machine” filed with the Korean Intellectual Property Office on Aug. 10, 2005 and assigned Serial No. 2005-73398, the contents of which are incorporated herein by reference.

### BACKGROUND OF THE INVENTION

1. Field of the Invention

The present invention relates generally to coin sorting machines and, in particular, to a coin sorting machine which rapidly sorts a great number of coins.

2. Description of the Related Art

Coin sorting machines sort various coins depending on the kinds of coins, and are mainly used in banks and stores, in which coins are frequently used.

Generally, the coin sorting machine sorts coins depending on the specific diameters of the coins. Such a coin sorting machine includes a coin sorting unit which sorts coins depending on the kinds of coins, and a storage unit which stores the sorted coins.

However, in the conventional coin sorting unit, when sorting a great number of coins, because the capacity of the storage unit is insufficient, a user should frequently empty the storage unit during a process of sorting coins. Therefore, there is a problem in that the coin sorting process cannot be rapidly performed.

To overcome the above-mentioned problem, a method of increasing the capacity of the storage unit may be used. However, in this case, the size of the coin sorting machine must be also increased, so that a large space is required. Furthermore, there is a problem in that the storage unit may interfere with other elements of the coin storage machine.

Moreover, in the conventional coin sorting machine, the storage unit is constructed as a drawer-type structure. Thus, to empty the storage unit, which is full of sorted coins, the operation of the coin sorting machine must be stopped before pulling out the coins. After emptying the storage unit, it must be repeatedly inserted into the coin sorting machine. As such, there are disadvantages in that the conventional coin sorting machine inconveniences the user, and the speed at which coins are sorted is relatively low.

### SUMMARY OF THE INVENTION

Accordingly, the present invention has been made keeping in mind the above problems occurring in the prior art, and an object of the present invention is to provide a coin sorting machine where storage casings are automatically carried, thereby enabling the sorting of a large number of coins rapidly.

In order to accomplish the above object, the present invention provides a coin sorting machine including a housing having a coin supply unit, through which coins are supplied into the housing, a coin sorting unit, which sorts the coins depending on kinds of the coins, a plurality of storage casings to store the sorted coins therein, a carrying unit and a storage casing inlet through which the storage casings are supplied. The storage casings each have a support having a carrying groove and a seating groove therein, and a storage part. The carrying unit includes a drive unit for rotating a plurality of rotating shafts, each of which has a screw thereon and is coupled to the support of each of the storage casings through the screw.

The coin sorting machine further includes a measurement and control unit for controlling the coin sorting unit and the carrying unit.

The measurement and control unit includes a plurality of drive sensors, each of which sends a signal when each of the storage casings is placed at a discharge position, at which the storage casing is removed, a plurality of limit sensors, each of which sends a signal when a predetermined number of coins is stacked in each of the storage casings, and a control unit to process signals transmitted from the drive sensors and the limit sensors, and to send a control signal.

The measurement and control unit further includes a plurality of counting sensors, each of which counts the coins to be stacked into each of the storage casings; and a control unit to process signals transmitted from the drive sensors and the counting sensors and send a control signal.

The measurement and control unit further includes a display to indicate operational conditions.

The carrying unit moves the storage casings on the rotating shafts from a storage position, at which the coins are inserted into the storage casings, to a discharge position, at which the storage casings are removed.

### BRIEF DESCRIPTION OF THE DRAWINGS

The above and other objects, features and advantages of the present invention will become more apparent from the following detailed description taken in conjunction with the accompanying drawings, in which:

FIG. 1 is a perspective view illustrating a coin sorting machine according to the present invention;

FIG. 2 is a sectional view taken along the line II-II of FIG. 1;

FIG. 3 is a sectional view taken along the line III-III of FIG. 2;

FIG. 4 is an exploded perspective view illustrating a coin supply unit and a coin sorting unit of the coin sorting machine of FIG. 1;

FIG. 5 is a perspective view illustrating a carrying slot formed in a first storage casing of the coin sorting machine of FIG. 1;

FIG. 6 is a perspective view illustrating a rotating shaft of the coin sorting machine of FIG.1; and

FIG. 7 is a sectional view illustrating the periphery of guides of a coin sorting machine according to a modification of the present invention.

### DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein is omitted to avoid making the subject matter of the present invention unclear.

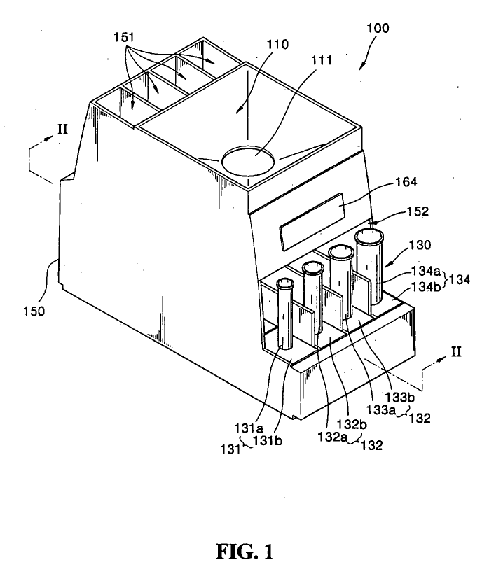

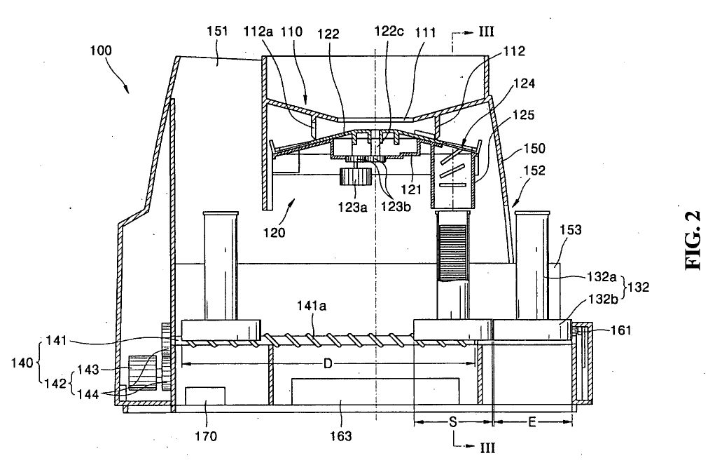

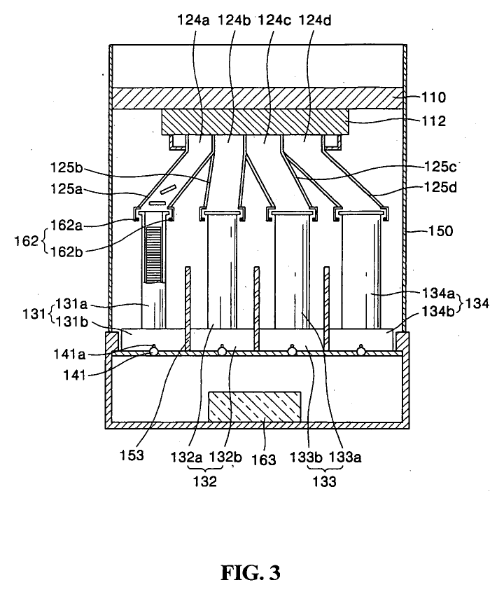

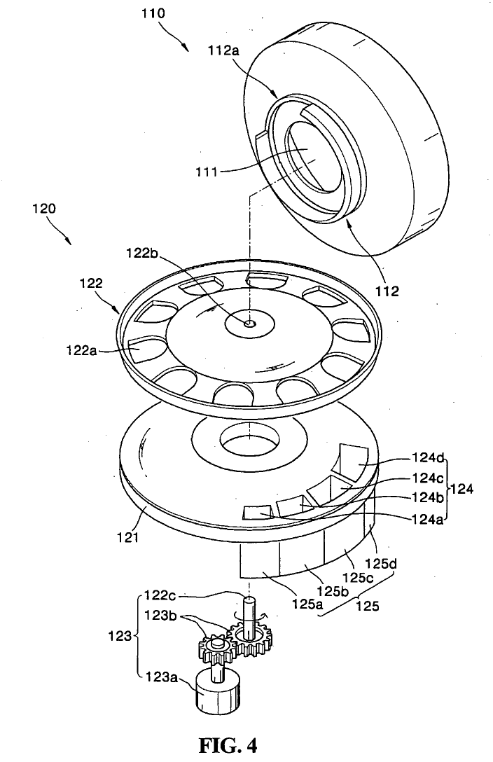

FIG. 1 is a perspective view illustrating a coin sorting machine 100 according to the present invention. FIG. 2 is a sectional view taken along the line II-II of FIG. 1. FIG. 3 is a sectional view taken along the line III-III of FIG. 2. FIG. 4 is an exploded perspective view illustrating a coin supply unit 110 and a coin sorting unit 120 of the coin sorting machine 100.

As illustrated in FIGS. 1, 2, 3 and 4, the coin sorting machine 100 includes the coin supply unit 110, the coin sorting unit 120, a plurality of storage casings 130, a plurality of carrying units 140 and a housing 150.

The coin supply unit 110 for inserting coins to be sorted is disposed at an upper portion of the housing 150. The coin supply unit 110 is integrated with the housing 150 and has a coin inlet 111 at a central portion thereof.

Further, a cylindrical blocking member 112 having an opening 112a through which coins pass is provided at a lower portion of the coin supply unit 110.

The coin supply unit 110 is integrated with the housing 150. Further, the coin supply unit can be manufactured through a separate process and mounted to the housing in an additional assembly process.

Hereinafter, the coin sorting unit 120 will be described with reference to FIGS. 2 and 4. The coin sorting unit 120 is disposed below the coin supply unit 110.

As illustrated in FIG. 4, the coin sorting unit 120 sorts coins supplied through the coin supply unit 110 depending on the kind of coin. The coin sorting unit 120 includes a base body 121, a rotating plate 122 and a rotating unit 123.

The base body 121 is mounted to the housing 150. A plurality of sorting holes 124 for sorting coins is formed around the perimeter of the base body 121.

The sorting holes 124 have different sizes depending on diameters of various kinds of coins to be sorted. In detail, the sorting holes 124 include a first sorting hole 124a, a second sorting hole 124b, a third sorting hole 124c and a fourth sorting hole 124d. Each sorting hole 124 has a predetermined size depending on the kind of coin to be sorted. In particular, the sorting hole each 124 has a size appropriate for corresponding to the kind of coin to pass therethrough.

Preferably, if coins are sorted into four kinds of coin depending on coin size, the first sorting hole 124a has a corresponding size to enable only the first kind of coin having the smallest diameters to pass therethrough, and the second sorting hole 124b has a size that enables the second kind of coin to pass therethrough but prevents the third kind of coin from passing therethrough. Further, the third sorting hole 124c has a size that enables the third kind of coin to pass therethrough but prevents the fourth kind of coin from passing therethrough, and the fourth sorting hole 124d has a corresponding size to enable even the fourth kind of coin having the largest diameter to pass therethrough.

For sorting four kinds of coins, the four sorting holes are formed in the base body 121. For example, in consideration of four kinds of US coins including 1 cent, 5 cents, 10 cents and 25 cents, four sorting holes are provided. Further, the total number of sorting holes may be changed depending on the number of kinds of coins used in the corresponding country.

The rotating plate 122 is disposed above the base body 121. A plurality of carrying holes 122a is formed around the perimeter of the rotating plate 122.

The cylindrical blocking member 112 is integrally provided under the coin supply unit 110. The cylindrical blocking member 112 is spaced apart from the rotating plate 122 by a distance less than the thickness of the thinnest kind of coin among the kinds of coins to be sorted.

Further, the cylindrical blocking member 112 has an opening 112a at a position opposite the portion in which the sorting holes 124 are formed. Therefore, the cylindrical blocking member 112 prevents coins that are fallen onto a central portion of the rotating plate 122 through the coin supply unit 110 from directly moving to the sorting holes 124. More particularly, after the coins have fallen onto the central portion of the rotating plate 122 through the coin inlet 111, the coins pass through the opening 112 of the cylindrical blocking member 112 to move to the carrying holes 122a of the rotating plate 122.

After the coins are inserted through the coin inlet 111, the coins are placed on the central portion of the rotating plate 122. The coins pass through the opening 112a by central force generated by rotation of the rotating plate 122. After the coins pass through the opening 112a, the coins are inserted into the carrying holes 112a. Then, the coins are carried to the sorting holes 124.

The rotating unit 123 for rotating the rotating plate 122 is provided below the base body 121.

The rotating unit 123 includes a sorting motor 123a, a speed reduction unit 123b and a shaft 122c. The shaft 122c is fitted into a center hole 122b of the rotating plate 122, and power is transmitted from the sorting motor 123a to the shaft 122c through the speed reduction unit 123b.

The power of the sorting motor 123a is transmitted to the shaft 122c of the rotating plate 122 through the speed reduction unit 123b. Further, the output shaft of the sorting motor is directly coupled to the center hole of the rotating plate so that power of the sorting motor is directly transmitted to the rotating plate.

As illustrated in FIG. 4, because the first kind of coin having the smallest diameter should fall through the first sorting hole 124a, the shaft 122c of the rotating plate 122 is rotated in a counterclockwise direction.

A plurality of guides 125 for carrying the sorted coins to the corresponding storage casings 130, is provided under the portion, in which the sorting holes 124 are formed.

The guides 125 are coupled to the respective sorting holes 124. More particularly, the guides 125 include a first guide 125a, a second guide 125b, a third guide 125c and a fourth guide 125d. The first, second, third and fourth guides 125a, 125b, 125c and 125d carry the coins to the corresponding storage casings 130 through the first sorting hole 124a, the second sorting hole 124b, the third sorting hole 124c and the fourth sorting hole 124d, respectively.

The storage casings 130 are classified into first storage casing 131, second storage casing 132, third storage casing 133 and fourth storage casing 134 depending on the kind of coins to be stored.

The first storage casing 131 includes a first storage part 131a and a first support 131b. The second storage casing 132 includes a second storage part 132a and a second support 132b. The third storage casing 133 includes a third storage part 133a and a third support 133b. The fourth storage casing 134 includes a fourth storage part 134a and a fourth support 134b.

Each of the storage parts 131a, 132a, 133a and 134a has a tubular shape and stores coins discharged from the corresponding guide 125.

The first, second, third and fourth supports 131b, 132b, 133b and 134b are provided under the first, second, third and fourth storage parts 131a, 132a, 133a and 134a to support the first, second, third and fourth storage parts 131a, 132a, 133a and 134a, respectively. A plurality of carrying grooves 135 for moving each kind of storage casing 130 is formed under the lower surface of each of the first, second, third and fourth supports 131b, 132b, 133b and 134b.

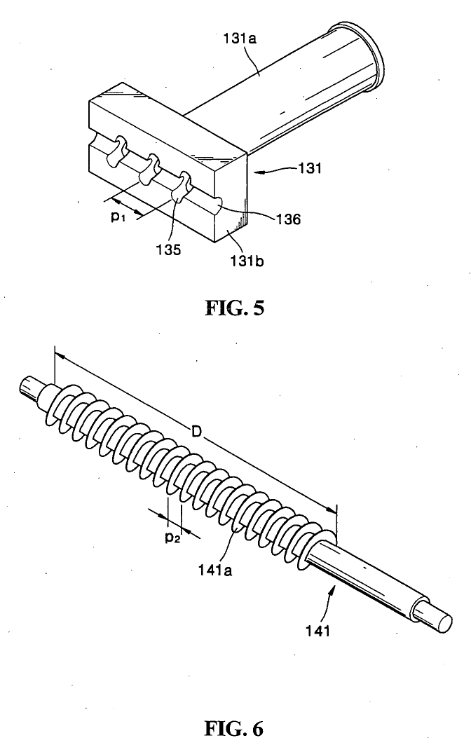

As illustrated in FIG. 5, the carrying grooves 135 having a predetermined pitch p₁, and a seating groove 136 are formed in the lower surface of each of the first, second, third and fourth supports 131b, 132b, 133b and 134b for receiving a rotating shaft 141 therein to guide the storage casings 130 such that the storage casings 130 are stably carried. Since the carrying grooves 135 engage with a screw 141a of each rotating shaft 141, the carrying grooves 135 are formed deeper than the seating groove 136.

Preferably, three carrying grooves 135 are formed in the support of each storage casing 130. Further, the number of carrying grooves formed in each support is determined depending on the size of the support and the pitch of the screw of the corresponding rotating shaft. More particularly, as the pitch of the screw is increased, the number of carrying grooves is reduced. However, as the length of the support is increased, the number of carrying grooves is increased.

Since the carrying grooves 135 engage with the screw 141a of the rotating shaft 141, the storage casing 130 having the carrying grooves 135 is moved in a predetermined direction depending on the direction in which the screw 141a is formed, when the rotating shaft 141 is rotated. More particularly, the storage casing 130 is advanced towards a storage casing outlet 152 by rotation of the rotating shaft 141.

The carrying unit 140 each carrying the corresponding storage casings 130 includes the rotating shaft 141 and a drive unit 142.

The number of carrying units 140 is the number of kinds of storage casings 130. Preferably, the four carrying units 140 are used to carry the four kinds of storage casings 130, and each carrying unit 140 defines a single carrying line.

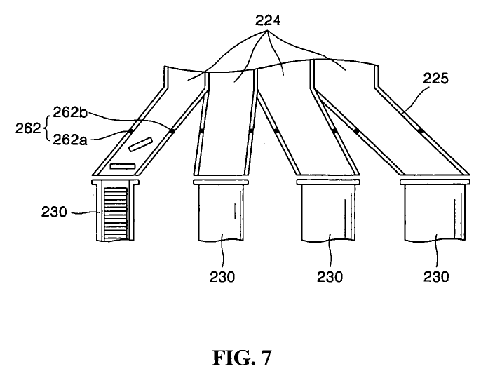

As illustrated in FIGS. 2 and 6, the screw 141a having a predetermined pitch p₂, is provided on each rotating shaft 141. As stated above, because each screw 141a engages with the corresponding carrying grooves 135, the pitch p₂ of the screw 141a is equal to the pitch p₁ of the corresponding carrying grooves 135.

The screw 141a is provided on the rotating shaft 141 within a screw formation range D. The screw 141a does not contact a storage casing 130, which is in a discharge position E around the storage casing outlet 152.

The screw 141a is provided on the rotating shaft 141 only within the screw formation range D. Further, a screw is provided along the entire length of the rotating shaft, other than the portion that is supported on a bearing. Alternatively, a screw is provided on a portion of the rotating shaft shorter than the portion of the rotating shaft having the screw formed thereon.

The drive unit 142 includes a motor 143 and a speed reduction unit 144. The speed reduction unit 144 transmits power of the motor 143 to the rotating shaft 141.

Spur gears are preferably used as the reduction unit Further, a power transmission unit uses other gears, such as helical gears, or a power transmission unit, such as a belt drive mechanism or a chain drive mechanism, as the speed reduction unit.

In the coin sorting machine 100, a coin storage position S is defined inside the housing 150, and the discharge position E is defined at the storage casing outlet 152. Thus, the storage casings 130, in which coins have been stacked, is easily discharged.

More particularly, the coin storage position S is defined just below the guides 125, and the stored coins fall into the guides 125. The discharge position E is defined ahead of the coin storage position S, and the storage casings 130, in which the coins are stacked, are discharged into the coin storage position S. Because the guides 125 are disposed in the housing 150, it is difficult for a user to directly pull out storage casings 130, which are at the coin storage position S. Therefore, the coins are stacked in the storage casings 130 at the coin storage position S. Then, the storage casings 130 are carried by the carrying units 140 to the discharge position E. Thus, the user can easily pull out the storage casings 130 at the discharge position (E).

The housing 150 includes a storage casing inlet 151, the storage casing outlet 152 and a plurality of partition walls 153. The storage casing inlet 151 is formed at an upper position of the housing 150. When the user supplies the storage casings 130 into the storage casing inlet 151, the supplied storage casings 130 are placed on the corresponding rotating shafts 140. The storage casing outlet 152 is formed at a predetermined position in a sidewall of the housing 150 and has an opening for easily pulling out the storage casings 130. The partition walls 153 are provided between the carrying lines, along which the corresponding storage casings 130 are carried. The partition walls 153 serve to separate the carrying lines and support the storage casings 130 when carried. The coin sorting machine 100 includes a measurement and control unit. The measurement and control unit includes a plurality of drive sensors 161, a plurality of limit sensors 162, a control unit 163 and a display unit 164.

The drive sensors 161 are mounted to the housing 150 at a position adjacent to the discharge position E. The drive sensor 161 has a contact switch.

When the storage casing 130 is completely placed at the discharge position (E) of the storage casing outlet 152, the storage casing 130 contacts the corresponding drive sensor 161. Then, the drive sensor 161 sends a signal to the control unit 163. The drive sensor 161 is provided in each carrying line, along which the corresponding storage casings 130 are carried.

The limit sensor 162 is provided on the lower end of each guide 125 at a position without interfering with the movement of the storage casings 130. The limit sensor 162 is preferably aligned with an upper end of the storage casing 130.

The limit sensor 162 sends a signal when a predetermined number of coins is loaded into the storage part 131 of the corresponding storage casing 130 at the storage position S for achieving a predetermined length of the stacked coins. Further, a non-contact light sensor is used as the limit sensor 162. The term “predetermined number” is a preset number of stacked coins to be rolled, for example, twenty, fifty or other numbers of coins.

Further, the limit sensor 162 is provided in each guide 125, respectively. The limit sensor 162 having a light sensor includes a light emitting device 162a and a light receiving device 162b. The light sensor is preferably used as the limit sensor 162, and a non-contact magnetic sensor or other type of sensor is also used. Preferably, a contact sensor is used as the drive sensor 161, and a non-contact sensor is used as the limit sensor 162.

The control unit 163 receives signals from the drive sensors 161 and the limit sensors 162, and controls the sorting motor 123a and the advancing motors 143. The control unit 163 can be made of an integrated circuit chip.

The display unit 164 indicates the operation state and control state of the coin sorting machine 100. The display unit 164 includes a light emitting diode (LED) and a liquid crystal display (LCD).

The operation of the coin sorting machine 100 will be described in detail herein below.

The user supplies the coins to be sorted into the coin inlet 111 of the coin supply unit 110 and supplies power to the coin sorting machine 100 using a power supply device 170.

The control unit 163 serving as the measurement and control unit determines whether a signal from the drive sensors 161 exists, and activates the motors 143 when there is no signal from the drive sensors 161.

When there is one or zero storage casings 130 in each carrying line, because the storage casing 130 cannot be completely placed in the discharge position E of the storage casing outlet 152, there is no signal from the corresponding drive sensor 161. More particularly, the screw 141a does not extend to a portion of the rotating shaft 141 corresponding to the discharge position E. Thus, when there is only one storage casing 130 in each carrying line, the storage casing 130 is not completely positioned at the discharge position E. Another storage casing 130 pushing the existing storage casing 130 is be present for completely placing the storage casing 130 at the discharge position E.

The user additionally supplies the storage casings 130 into the storage casing inlet 151. Then, the storage casing 130 is carried by the corresponding rotating shaft 141. Then, the frontmost storage casing 130 is pushed by the storage casing 130, completely positioned at the discharge position (E), and the corresponding drive sensor 161 is operated. The following storage casing 130 is completely positioned at the storage position (S) such that coins discharged from the corresponding guide 125 are correctly stored thereinto.

When the drive sensor 161 sends a signal indicating that the storage casing 130 is completely placed at the discharge position E is complete, the control unit 163 activates the sorting motor 123a.

The coins inserted into the coin inlet 111, are placed on the rotating plate 122 of the coin sorting unit 120. When the sorting motor 123a is operated, the coins are moved by centrifugal force of the rotating plate 122 towards the circumferential outer edge of the rotating plate 122 and are inserted into the carrying holes 122a through the opening 112a of the cylindrical blocking member 112. The coins inserted into the carrying holes 122a are moved to the sorting holes 124 of the base member 121 by rotation of the rotating plate 122. The sorting holes 124 have different sizes depending on the diameters of kinds of coins to be sorted. Thus, each kind of coin can pass through the associated sorting hole 124. The coins, having passed through the sorting holes 124, are moved along the corresponding guides 125. The end of each guide 125 communicates with the corresponding storage casing 130, so that the coins are stacked into the storage casings 130, which are placed at the storage position S, after passing through the guides 125.

The above-described operation is continuously conducted until the height of coins stacked in one storage casing reaches a predetermined height. More particularly, once the height of coins stacked in the first storage part 131a of the first storage casing 131 reaches the predetermined stacking height, even if the heights of coins stacked in the remaining second, third and fourth storage parts 132a, 133a and 134a have not reached the predetermined heights, the operation of sorting coins is stopped.

The limit sensor 162, which is mounted to the corresponding guide 125, sends a signal when the coins inserted into the corresponding storage casing 130 are stacked to the predetermined height. Then, the control unit 162 receives the signal transmitted from the limit sensors 162 and stops the sorting motor 123a.

After the sorting motor 123a is stopped, the user removes the storage casings 130 placed in the discharge positions E of the storage casing outlet 152, from the coin sorting machine 100 and supplies new storage casings 130 into the storage casing inlet 151. The first storage casings 130 to be discharged are empty.

When the user removes the storage casings 130 from the discharge position E, the drive sensors 161 do not send any signal and the control unit 163 operates the motors 143.

When the motors 143 are operated, the storage casings 130 are pushed out by the empty storage casings 130 delivered to the discharge position E. When the drive sensors 161 send signals indicating that the storage casings 130 are completely placed at the discharge position E, the control unit 163 operates the sorting motor 123a for sorting coins.

When the height of coins stacked in any storage casing 130 at the storage position S reaches the predetermined stacking height, the control unit 163 receives a signal from the corresponding limit sensor 162 and stops the sorting motor 123a

When the sorting motor 123a is stopped, the user removes the storage casings 130 placed at the discharge position E from the coin sorting machine 100 and supplies new storage casings 130 into the storage casing inlet 151.

The storage casing 130, which has been first removed from the discharge position E of the storage casing outlet 152, is empty, but the coins are stacked to a predetermined height in the storage casing 130 that is secondly removed from the discharge position E.

After the user has removed the storage casings 130 from the coin sorting machine 100, the coins are removed from the storage casings 130 and wrapped with paper wraps. Since the storage casings 130 are easily moved, removed and installed, the coins can be efficiently wrapped.

The above-described operation is conducted in the same manner in other carrying lines having the different kinds of storage casings 130 and is maintained until the user turns off power.

The storage casings 130 are automatically carried, so that coins can be rapidly stored in the storage casings 130, and the storage casings 130 are easily and rapidly removed. Therefore, the sorting speed of the coin sorting machine 100 is increased.

Hereinafter, another embodiment of the present invention will be described with reference to FIG. 7.

FIG. 7 is a sectional view illustrating the periphery of guides 225 of a coin sorting machine according to another embodiment of the present invention.

As illustrated in FIG. 7, the coin sorting machine according to another embodiment of the present invention includes counting sensors 262 provided in the respective guides 225. The coin sorting machine counts as well as sorts the coins.

The counting sensor 262 is provided in each guide 225. The counting sensor 262 detects the coins falling from a corresponding sorting hole 224, and has a non-contact light sensor. The counting sensor 262 is disposed at any position in the guide 225. The counting sensors 262 are disposed at positions at which the limit sensors 162 are disposed.

The counting sensor 262 sends a signal when it detects the coin falling along the guide 225. A counting sensor 262 is provided in each guide 225.

The counting sensor 262 having a light sensor includes a light emitting device 262a and a light receiving device 262b.

A light sensor is preferably used as the counting sensor 262, and a non-contact magnetic sensor, contact sensor or other sensor is also used.

A control unit (not shown) according to another embodiment receives signals from the counting sensors 262 to count coins and sends control signals depending on the number of stacked coins.

Another embodiment of the present invention does not require a limit sensor, since the number of stacked coins is estimated using signals transmitted from the counting sensor 262. Thus, when the number of coins stacked in the storage casing 230 corresponds to the preset number of coins, the control unit (not shown) controls a sorting motor (not shown) and motors (not shown).

In the coin sorting machine according to this embodiment of the present invention, the user can easily know the amount of stacked coins using a display unit, and saves data about the number of counted coins in the control unit.

Further, the coin sorting machine automatically carries the storage casings 230, so that coins can be rapidly stored in the storage casings 230, and the storage casings 230 are rapidly removed from the coin sorting machine. Further, because the coins are counted using the counting sensors 262, there are advantages in that the speed at which the coins are sorted is increased and the performance of the coin sorting machine is further enhanced.

As described above, the coin sorting machine of the present invention has a structure such that storage casings are automatically carried for rapidly sorting a great number of coins.

Further, because each storage casing is carried by a rotating shaft having a screw, processes of supplying and removing the storage casings are rapidly conducted. Therefore, the speed at which coins are sorted is markedly increased.

Furthermore, there is an advantage in that the number of coins can be automatically counted while the coins are sorted.

In addition, the coin sorting machine of the present invention makes it easy to wrap the sorted coins.

Although the preferred embodiment of the present invention has been disclosed for illustrative purposes, those skilled in the art will appreciate that various modifications, additions and substitutions are possible. Therefore, the technical scope of the present invention must be defined by the technical spirit of the accompanying claims.

What is claimed is:

1. A coin sorting machine having a housing, comprising:
a coin supply unit for supplying coins into the housing;
a coin sorting unit for sorting the coins depending on kinds of coins, the coin sorting unit being disposed below the coin supply unit;
a plurality of storage casings for storing the sorted coins, the storage casings being disposed below the coin sorting unit and including a support having a carrying groove and a seating groove therein, and a storage part;
a carrying unit corresponding to the storage casings, the carrying unit comprising a drive unit for rotating a plurality of rotating shafts, wherein each rotating shaft has a screw thereon and is coupled to the support of each of the storage casings through the screw; and
a storage casing inlet, wherein the storage casings are supplied through the storage casing inlet.

2. The coin sorting machine as set forth in claim 1, further comprising:
a measurement and control unit for controlling the coin sorting unit and the carrying unit.

3. The coin sorting machine as set forth in claim 2, wherein the measurement and control unit comprises:
a plurality of drive sensors, the drive sensors sending a signal when each of the storage casings is placed at a discharge position, at which the storage casing is removed;
a plurality of limit sensors, the limit sensors sending a signal when a predetermined number of coins is stacked in each of the storage casings; and
a control unit for processing signals transmitted from the drive sensors and the limit sensors, and for sending a control signal.

4. The coin sorting machine as set forth in claim 2, wherein the measurement and control unit comprises:
a plurality of drive sensors, the drive sensors sending a signal when each of the storage casings is placed at a discharge position, at which the storage casing is removed;
a plurality of counting sensors, the counting sensors counting the coins to be stacked into each of the storage casings; and
a control unit for processing signals transmitted from the drive sensors and the counting sensors, and for sending a control signal.

5. The coin sorting machine as set forth in claim 3, wherein the measurement and control unit further comprises a display for indicating operational conditions.

6. The coin sorting machine as set forth in claim 4, wherein the measurement and control unit further comprises a display for indicating operational conditions.

7. The coin sorting machine as set forth in claim 1, wherein the carrying unit moves the storage casings on the rotating shafts from a storage position, at which the coins are inserted into the storage casings, to a discharge position, at which the storage casings are removed.
